(19) United States
(12) Patent Application Publication
(10) Pub. No.: US 2026/0192572 A1
(43) Pub. Date: Jul. 9, 2026

(54) PRINTER, METHOD, AND STORAGE MEDIUM

(71) Applicant: Toshiba Tec Kabushiki Kaisha, Tokyo (JP)

(72) Inventor: Shunsuke AOKI, Sunto Shizuoka (JP)

(21) Appl. No.: 19/351,218

(22) Filed: Oct. 6, 2025

(30) Foreign Application Priority Data
Jan. 9, 2025 (JP) 2025-003168

(51) Int. Cl. B41J 2/355; B41J 2/365

(52) U.S. Cl. CPC B41J 2/3555; B41J 2/365

(57) ABSTRACT

A printer includes a thermal head including multiple heating elements arranged in a line; a memory; and a processor configured to execute a program stored in the memory to perform the steps of: obtaining print data to be printed, determining a characteristic of the print data, and controlling the thermal head to print the print data line by line using thermal history control based on the determined characteristic of the print data. The thermal history control controls an amount of heat to be generated by each of the heating elements considering an amount of heat that has been stored in the each of the heating elements during a process of printing the print data.

### CROSS-REFERENCE TO RELATED APPLICATION

This application is based upon and claims the benefit of priority from Japanese Patent Application No. 2025-003168, filed Jan. 9, 2025, the entire contents of which are incorporated herein by reference.

### FIELD

Embodiments described herein relate generally to a printer, a method, and a storage medium.

### BACKGROUND

A known printer, such as a thermal printer, prints, for example, characters on a recording medium using a print head including multiple heating elements arranged in a width direction (hereinafter also referred to as a line direction) that intersects the sheet conveyance direction.

The printer described above performs control to print data line by line. The print data represents information, such as characters, using dots. Also, there is a technology called thermal history control that controls the amount of heat generated by each heating element based on the heat generation history of the heating element to take into account the amount of heat stored in the heating element during a printing process.

However, with the conventional thermal history control technology, it is difficult to flexibly control the amount of heat generated by each heating element according to the content and type of print data. Therefore, depending on the content and type of print data, thermal history control cannot be performed effectively, and print quality may be reduced.

### SUMMARY OF THE INVENTION

Embodiments of this disclosure provide a printer, a method, and a storage medium that make it possible to improve print quality.

An aspect of the present disclosure provides a printer that includes a thermal head including multiple heating elements arranged in a line; a memory; and a processor configured to execute a program stored in the memory to perform the steps of: obtaining print data to be printed, determining a characteristic of the print data, and printing the print data line by line while performing thermal history control according to the determined characteristic of the print data to control the amount of heat generated by each of the heating elements considering an amount of heat stored in the each of the heating elements during a process of printing the print data.

### BRIEF DESCRIPTION OF THE DRAWINGS

FIG. 1 is a diagram illustrating a schematic configuration of a printer according to an embodiment.

FIG. 2 is a diagram illustrating an example of a hardware configuration of the printer.

FIG. 3 is a diagram illustrating an example of a data structure of strobe setting information.

FIG. 4 is a diagram for describing an example of application timing of a strobe.

FIG. 5 is a diagram illustrating an example of a data structure of target dot setting information.

FIG. 6 is a diagram illustrating an example of a functional configuration of the printer.

FIG. 7 is a diagram showing an example of print data.

FIG. 8 is a diagram showing an example of a state in which application patterns are set in the print data of FIG. 7.

FIG. 9 is a diagram showing an example of print data.

FIG. 10 is a diagram showing an example of a state in which application patterns are set in the print data of FIG. 9.

FIG. 11 is a flowchart showing an example of a process performed by the printer.

### DETAILED DESCRIPTION

Hereinafter, embodiments will be described in detail with reference to the drawings. Note that the present disclosure is not limited to the embodiments described below.

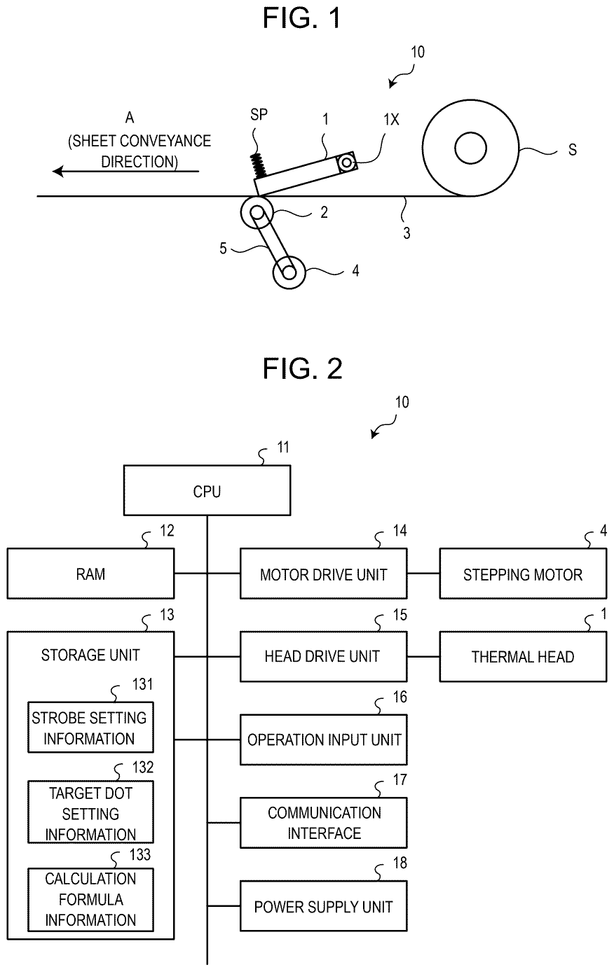

FIG. 1 is a diagram illustrating a schematic configuration of a printer 10 according to an embodiment. As shown in FIG. 1, the printer 10 includes a thermal head 1 and a platen roller 2. The thermal head 1 and the platen roller 2 are disposed to face each other to sandwich a sheet 3 that is an example of a recording medium and supplied from rolled continuous paper S.

The thermal head 1 is an example of a print head. One end of the thermal head 1 is supported so as to be freely rotatable around a rotation shaft 1X. The other end of the thermal head 1 is biased by a biasing member SP so as to be pressed against the platen roller 2.

The platen roller 2 is an example of a conveying roller. A stepping motor 4 is an example of a driving device (conveying motor). The stepping motor 4 is provided for the platen roller 2 and applies a rotational driving force to the platen roller 2. Specifically, the platen roller 2 is coupled to the stepping motor 4 via, for example, a belt 5 for transmitting the rotational driving force of the stepping motor 4 to the platen roller 2. When the stepping motor 4 rotates, the platen roller 2 is rotated by the rotation of the stepping motor 4 via the belt 5.

The sheet 3 is an example of a printing medium. The sheet 3 is, for example, a thermal sheet, such as a label sheet. The sheet 3 is sandwiched between the thermal head 1 and the platen roller 2 and is conveyed leftward in FIG. 1 (in a sheet conveyance direction A) by the rotation of the platen roller 2.

The thermal head 1 includes multiple heating elements (not shown) arranged in a line along the width direction of the sheet 3 (or a line direction) that intersects the conveyance direction of the sheet 3. The thermal head 1 causes heating elements (or selected heating elements among the heating elements of the thermal head 1) corresponding to dots (or print dots) to be printed on the sheet 3 to generate heat. With this configuration, the thermal head 1 prints print data, which represents, for example, characters, symbols, or drawings, on the sheet 3 being conveyed. The print data is constituted by one or more lines, and the thermal head 1 prints the print data line by line.

The printer 10 applies strobe signals to the heating elements of the thermal head 1 and thereby causes the heating elements to generate heat. The printer 10 applies the generated heat to the sheet 3 to cause the sheet 3 to develop color, thereby printing an image corresponding to print data on the sheet 3.

The configuration of the printer 10 is not limited to that shown in FIG. 1. For example, the printer 10 may further include a roller for extracting the sheet 3 from the rolled continuous paper S and feeding the sheet 3 toward the platen roller 2 and a cutter mechanism for cutting the sheet 3 on which information has been printed. In the present embodiment, a conveyance unit for conveying the sheet 3 includes the platen roller 2, the stepping motor 4, and a motor drive unit 14 (see FIG. 2) described later. However, the configuration of the conveyance unit is not limited to this example, and the conveyance unit may further include other components, such as a roller for extracting the sheet 3 and a drive source for the roller. Here, any one or more of the platen roller 2, the stepping motor 4, and the motor drive unit 14 may be referred to as a conveyance unit that conveys the sheet 3.

FIG. 2 is a diagram illustrating an example of a hardware configuration of the printer 10 according to the embodiment. As illustrated in FIG. 2, the printer 10 has a computer configuration including a CPU (Central Processing Unit) 11, a RAM (Random Access Memory) 12, and a storage unit 13. Each of the RAM 12 and the storage unit 13 is an example of a non-transitory computer-readable storage medium.

The CPU 11 is an example of a processor and controls the entire printer 10. The RAM 12 is a volatile storage memory and is used as a workspace for the CPU 11. For example, the RAM 12 is used as a buffer area for temporarily storing print data to be printed on the sheet 3.

The storage unit 13 is a non-volatile memory, such as a ROM (Read Only Memory) or a flash memory. The storage unit 13 stores various programs to be executed by the CPU 11 and setting information. For example, the storage unit 13 stores a program related to a print control process described below. The storage unit 13 also stores various types of setting information related to the print control process. For example, the storage unit 13 stores strobe setting information 131, target dot setting information 132, calculation formula information 133, etc. The strobe setting information 131, the target dot setting information 132, and the calculation formula information 133 will be described later.

In addition, a motor drive unit 14 and a head drive unit 15 are connected to the CPU 11. The motor drive unit 14 controls the operation of the stepping motor 4 by supplying electricity to the stepping motor 4. Specifically, under the control of the CPU 11, the motor drive unit 14 generates a current waveform for driving (or rotating) the stepping motor 4. Then, the motor drive unit 14 energizes the stepping motor 4 using the generated current waveform, thereby rotating the stepping motor 4.

The head drive unit 15 controls the operation of the thermal head 1 by supplying electricity to the thermal head 1. Specifically, under the control of the CPU 11, the head drive unit 15 generates a pulse signal (hereinafter also referred to as a strobe) for driving the thermal head 1 (or causing the thermal head 1 to generate heat). Then, the head drive unit 15 uses the generated strobe to cause the heating elements of the thermal head 1 to generate heat.

In addition, an operation input unit 16 and a communication interface (I/F) 17 are connected to the CPU 11. The operation input unit 16 includes various keys that enable the user to operate the printer 10. Operation instructions entered via the operation input unit 16 are input to the CPU 11. For example, when an operation instruction to start printing is entered via the operation input unit 16, the CPU 11 controls the motor drive unit 14 and the head drive unit 15 to start printing on the sheet 3.

The communication interface 17 is an interface for communicating with a host device (or an external device), such as a POS terminal. The communication interface 17 supports, for example, IrDA, USB (Universal Serial Bus), LAN (Local Area Network), RS-232C, Bluetooth (registered trademark), etc. The CPU 11 transmits and receives various types of information to and from the host device via the communication interface 17.

For example, the CPU 11 obtains print data transmitted from the host device via the communication interface 17. The host device may be configured to transmit information (hereinafter also referred to as characteristic information) indicating the characteristic of the print data to the printer 10 along with the print data. In this case, for example, the host device may transmit a predetermined bit value indicating the characteristic of the print data as the characteristic information. For example, the host device may transmit, as characteristic information, a bit value of “0” when the print data is alphabetic data described below and transmit a bit value of “1” when the print data is kanji data described below.

The printer 10 prints, line by line, print data representing a print target, such as a character, using dots. The print data is, for example, raster data, and an image such as a character string is represented by a collection of small dots called pixels (hereinafter also referred to as dots). In print data for each line, parts to be printed by heating elements are specified. The printer prints a print target such as a character, line by line, by causing heating elements (or selected heating elements among the heating elements of the thermal head 1) corresponding to dots representing the print target. Note that in the present embodiment, the color depth of each dot is 1 bpp (bits per pixel), and whether a dot is to be printed is indicated by a binary bit value of 1 (black) or 0 (white).

Print data obtained from the host device is temporarily stored in the RAM 12, and an image corresponding to the print data is printed on the sheet 3 under the control of the CPU 11. More specifically, the CPU 11 controls the motor drive unit 14 to rotate the stepping motor 4 and thereby convey the sheet 3 in the sheet conveyance direction A. The CPU 11 also controls the operation of the head drive unit 15 based on the print data and thereby prints, for example, characters corresponding to the print data on the sheet 3 conveyed in the sheet conveyance direction A.

The printer 10 also includes a power supply unit 18. The power supply unit 18 is detachably connected to a commercial power supply (not shown) via a connector (e.g., a connection plug or a socket) or the like. The power supply unit 18 converts an AC voltage supplied from the commercial power supply into a DC voltage usable by the printer 10 and then supplies the DC voltage to each component of the printer 10 via a power supply line (not shown). The power supply unit 18 may include a power switch for establishing and breaking the electrical connection with the commercial power supply. The power supply unit 18 may instead be a rechargeable secondary battery.

Next, the strobe setting information 131, the target dot setting information 132, and the calculation formula information 133 stored in the storage unit 13 will be described.

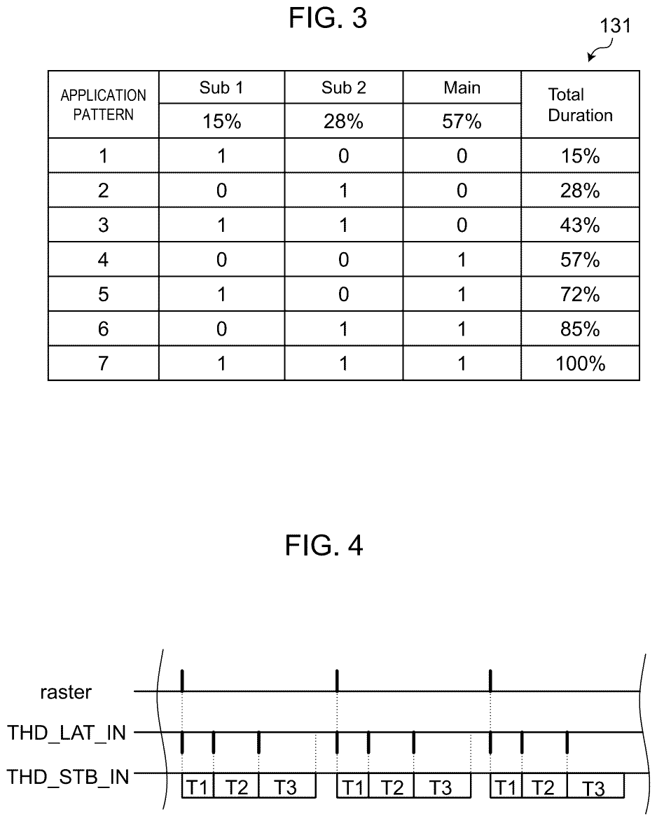

The strobe setting information 131 includes setting information related to a strobe applied to heating elements. FIG. 3 is a diagram showing an example of a data structure of the strobe setting information 131 according to the embodiment. As shown in FIG. 3, the strobe setting information 131 is a data table that associates the on and off states of a strobe applied in multiple stages with the printing density of a dot.

Note that FIG. 3 shows an example of a data structure when a strobe is applied in three stages: Sub 1, Sub 2, and Main. Sub 1, Sub 2, and Main represent durations for which the strobe is applied. The durations represented by Sub 1, Sub 2, and Main are different from each other. In FIG. 3, the total duration is 100% when the strobe is turned on (strobe value=1) in all of Sub 1, Sub 2, and Main. FIG. 3 shows the percentage of the total duration of Sub 1, Sub 2, and Main for each combination of on and off states.

FIG. 4 is a diagram for describing an example of application timing of a strobe. “Raster” on the vertical axis represents one line of print data, and each thick line indicates the timing at which one line of print data is obtained. “THD_LAT_N” indicates the timing at which print data is transferred to the thermal head, and each thick line indicates the timing of transfer. “THD_STB_N” indicates the timing and duration of the application of the strobe.

As shown in FIG. 4, the printer 10 applies a strobe in three stages: T1, T2, and T3. Here, T1 corresponds to Sub 1, T2 corresponds to Sub 2, and T3 corresponds to Main. In other words, the printer 10 applies the strobe in the order of Sub 1, Sub 2, and Main. The transfer timing of the print data is synchronized with the start timing (or application timing) of T1, T2, and T3.

Returning to FIG. 3, in the strobe setting information 131, a binary value (hereinafter referred to as a strobe value), which turns heat generation on or off, is set for each of application durations Sub 1, Sub 2, and Main. A strobe value of “1” indicates that a strobe is applied, and a strobe value of “0” indicates that no strobe is applied (or a strobe indicating not to generate heat is applied). The strobe setting information 131 includes seven application patterns each of which is a combination of strobe values specified for Sub 1, Sub 2, and Main. Here, a greater application pattern number indicates a longer application duration.

The printer 10 performs heat generation control (or thermal history control described later) considering the influence of heat stored in each heating element during a printing process by selecting one of the application patterns defined in the strobe setting information 131 based on calculation formulas described later. The strobe setting information 131 may include eight application patterns including an application pattern in which all the strobe values for Sub 1, Sub 2, and Main are set to “0”.

The target dot setting information 132 includes dot setting information related to thermal history control. Thermal history control is a technology for controlling the amount of heat generated by each heating element based on the amount of heat stored during a process of printing print data. In thermal history control, each of dots included in each of lines constituting print data is set as a target dot to be processed, and the amount of heat generated by a heating element for printing the target dot, i.e., the application duration of a strobe, is controlled based on the bit values of the target dot and other dots (hereinafter also referred to as surrounding dots) around the target dot.

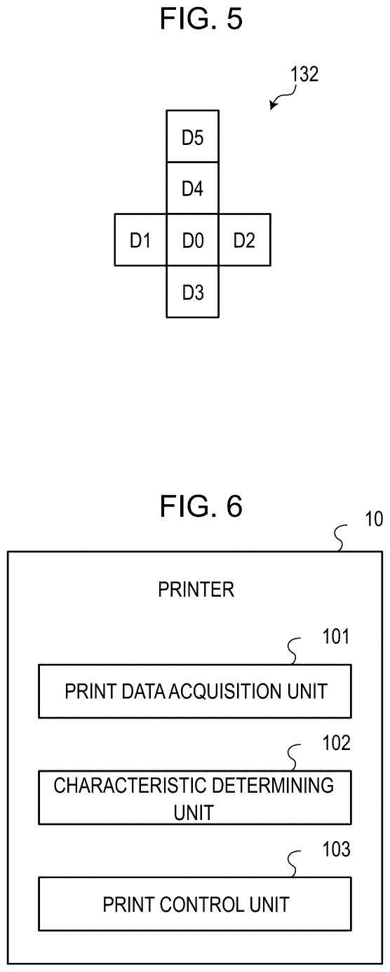

FIG. 5 is a diagram showing an example of a data structure of the target dot setting information 132 according to the embodiment. As shown in FIG. 5, the target dot setting information 132 defines the positional relationship between the target dot (“D0” in the figure) and surrounding dots.

Here, the surrounding dots include a left dot “D1” and a right dot “D2” that are adjacent to and horizontally aligned with the target dot “D0”. The surrounding dots also include a future dot “D3” that is adjacent to the target dot “D0” and is included in a line to be printed immediately after the line including the target dot “D0”. The surrounding dots also include a first past dot “D4” that is adjacent to the target dot “D0” and is included in a line printed immediately before the line including the target dot “D0”. The surrounding dots also include a second past dot “D5” that is adjacent to the first past dot “D4” and is included in a line printed immediately before the line including the first past dot “D4”.

In the present embodiment, the printer 10 sets each of dots in each of lines constituting print data as a target dot. Then, based on the target dot setting information 132, the printer 10 substitutes the bit values (0 or 1) of the target dot and the surrounding dots into calculation formulas (described later) to derive (or determine) strobe values for Sub 1, Sub 2, and Main.

It should be noted that the data structure of the target dot setting information 132 is not limited to that shown in FIG. 5. For example, the target dot setting information 132 may specify the positional relationship of dots other than the second past dot “D5”. Also, the target dot setting information 132 may specify the positional relationship of dots other than the future dot “D3”.

The calculation formula information 133 includes calculation formulas for deriving strobe values for Sub 1, Sub 2, and Main based on the bit values of the target dot and the surrounding dots. Specifically, the calculation formula information 133 includes multiple sets of calculation formulas corresponding to characteristics of multiple types of print data. Here, each characteristic of print data is related to information represented by the print data. More specifically, each characteristic of print data refers to a characteristic related to the density of dots, such as the interval between dots (hereinafter also referred to as print dots) to be printed or the concentration of dots.

For example, characteristics of print data can be classified according to whether the majority (e.g., more than half) of characters to be printed by the print data are alphabetic data consisting of alphabetic characters or kanji data consisting of kanji characters. In kanji data, compared with alphabetic data, the interval between print dots is narrower, and the density of dots tends to be higher. In addition, for example, characteristics of print data can be classified according to whether the majority (e.g., more than half) of the characters to be printed by the print data are one-byte characters or two-byte characters. In this case, because two-byte characters include kanji characters, the density of dots tends to be higher compared to one-byte characters. Furthermore, for example, characteristics of print data can be classified according to whether information to be printed is a code symbol such as a barcode or a graphic such as an illustration or a photograph. In this case, because the interval between print dots is wider in a code symbol, the density of a code symbol tends to be lower compared to a graphic.

The calculation formula information 133 includes, for each characteristic of print data, a set of calculation formulas for deriving strobe values for Sub 1, Sub 2, and Main. For example, the calculation formula information 133 includes a set of calculation formulas for alphabetic data and a set of calculation formulas for kanji data.

Here, each calculation formula is expressed as a logical expression the elements of which are the bit values of a target dot and surrounding dots. The logical expressions representing calculation formulas differ from each other depending on the characteristics of print data. Specifically, a logical expression is set (designed) for each print data characteristic, such as the interval or density of print dots including a target dot and surrounding dots, taking into account the influence of heat accumulation during a printing process so that printing can be performed efficiently and accurately.

A calculation formula is provided for each of Sub 1, Sub 2, and Main. A calculation formula for each of Sub 1, Sub 2, and Main is set (or designed) to derive a strobe value based on a characteristic such as the interval or density of print dots including a target dot and surrounding dots so that an amount of heat reflecting the influence of heat accumulation during a printing process can be generated by the heating element corresponding to the target dot. Specifically, the total application duration of an application pattern corresponding to a set of strobe values derived by the calculation formulas for Sub 1, Sub 2, and Main corresponds to the amount of heat that reflects the influence of heat accumulation during a printing process.

Formulas (1) to (3) below are examples of calculation formulas for alphabetic data. Formulas (4) to (6) below are examples of calculation formulas for kanji data.

$$V 1 = ( v 1 \& ! v 2 \& ! v 3 \& ! v 4 \& ! v 5 ) \vert ( v 0 \& v 1 \& ! v 3 \& ! v 5 ) \vert ( v 0 \& ! v 1 \& v 3 \& v 4 ) \vert ( v 0 \& ! v 1 \& v 2 \& v 4 ) \vert ( v 0 \& ! v 1 \& v 4 \& v 5 ) \vert ( v 0 \& v 2 \& ! v 4 \& v 5 ) \vert ( v 0 \& v 1 \& ! v 2 \& v 3 ) \vert ( v 0 \& ! v 1 \& ! v 4 \& v 5 ) \vert ( v 0 \& v 1 \& v 4 ) \qquad ( 1 )$$

$$V 2 = ( v 0 \& ! v 1 \& ! v 2 \& ! v 3 \& ! v 4 ) \vert ( v 0 \& ! v 1 \& v 3 \& v 4 ) \vert ( v 0 \& ! v 1 \& v 2 \& v 4 ) \vert ( v 0 \& ! v 1 \& v 4 \& v 5 ) \vert ( v 0 \& ! v 4 \& ! v 5 ) \qquad ( 2 )$$

$$V 3 = ( v 0 \& v 1 \& ! v 2 \& ! v 3 \& ! v 4 ) \vert ( v 0 \& ! v 2 \& ! v 3 \& ! v 5 ) \vert ( v 0 \& v 2 \& ! v 4 \& v 5 ) \vert ( v 0 \& v 1 \& ! v 2 \& v 3 ) \vert ( v 0 \& ! v 1 \& ! v 4 \& v 5 ) \vert ( v 0 \& ! v 4 \& ! v 5 ) \vert ( v 0 \& v 1 \& v 4 ) \qquad ( 3 )$$

$$V 1 = ( v 1 \& ! v 2 \& ! v 3 \& ! v 4 \& ! v 5 ) \vert ( v 0 \& v 1 \& v 2 \& v 3 \& v 5 ) \vert ( v 0 \& v \& ! v 2 \& ! v 5 ) \vert ( v 0 \& ! v 1 \& v 5 ) \vert ( v 0 \& v 1 \& ! v 3 \& ! v 5 ) \vert ( v 0 \& ! v 1 \& ! v 4 \& v 5 ) \vert ( v 0 \& v 3 \& v 4 ) \vert ( v 0 \& v 2 \& v 4 ) \qquad ( 4 )$$

$$V 2 = ( v 0 \& v 1 \& v 2 \& v 3 \& v 5 ) \vert ( v 0 \& v 1 \& ! v 2 \& ! v 3 \& ! v 4 ) \vert ( v 0 \& ! v 1 \& v 4 \& v 5 ) \vert ( v 0 \& v 3 \& v 4 ) \vert ( v 0 \& v 2 \& v 4 ) \vert ( v 0 \& ! v 4 \& ! v 5 ) \qquad ( 5 )$$

$$V 3 = ( v 0 \& ! v 2 \& ! v 3 \& ! v 5 ) \vert ( v 0 \& ! v 1 \& ! v 2 \& ! v 3 ) \vert ( v 0 \& ! v 1 \& ! v 4 \& v 5 ) \vert ( v 0 \& ! v 3 \& ! v 4 ) \vert ( v 0 \& ! v 2 \& ! v 4 ) \vert ( v 0 \& ! v 4 \& ! v 5 ) \qquad ( 6 )$$

In formulas (1) to (6), V1 on the left-hand side indicates a strobe value for Sub 1, V2 indicates a strobe value for Sub 2, and V3 indicates a strobe value for Main. Parentheses ( ) on the right-hand side separate terms, and | is the OR operator. In the terms, v0 corresponds to the bit value of the target dot D0, v1 corresponds to the bit value of the left dot D1, v2 corresponds to the bit value of the right dot D2, v3 corresponds to the bit value of the future dot D3, v4 corresponds to the bit value of the first past dot D4, and v5 corresponds to the bit value of the second past dot D5. Also, & is the AND operator, and ! is the NOT operator.

For example, v1 &! v2 indicates that the bit value of v2 is first inverted, and then an AND operation is performed between the bit value of v1 and the inverted bit value of v2. In this case, when v1 is “1” and v2 is “1”, the inverted bit value of v2 is “0”, and the operation result of 1 & 0 is 0.

In the calculation formulas for alphabetic data and the calculation formula for kanji data described above, logical expressions for the bit values of the target dot and the surrounding dots are preset based on a characteristic such as the interval or density of dots so as to reduce the influence of heat accumulation during a printing process.

The printer 10 derives strobe values V1 to V3, i.e., an application pattern for Sub 1, Sub 2, and Main, for each of target dots by using calculation formulas corresponding to the characteristic of print data. The printer 10 then prints the print data by applying a strobe to each of the target dots based on the derived application patterns.

Next, a functional configuration of the printer 10 will be described. FIG. 6 is a diagram showing an example of a functional configuration of the printer 10 according to the embodiment. As shown in FIG. 6, the printer 10 includes a print data acquisition unit 101, a characteristic determining unit 102, and a print control unit 103 as functional components.

Specifically, the CPU 11 of the printer 10 reads a program from the storage unit 13, loads the program into the RAM 12, and executes the loaded program to generate the print data acquisition unit 101, the characteristic determining unit 102, and the print control unit 103 on the RAM 12. Note that the print data acquisition unit 101, the characteristic determining unit 102, and the print control unit 103 are not limited to software components implemented by the cooperation between the CPU 11 and the program and may also be implemented by hardware components, such as dedicated circuits.

The print data acquisition unit 101 is an example of an acquisition unit. The print data acquisition unit 101 acquires print data transmitted from a host device via the communication interface 17. The print data acquisition unit 101 stores the acquired print data in the RAM 12 or the like.

Also, when characteristic information of the print data is transmitted from the host device together with the print data, the print data acquisition unit 101 acquires the characteristic information and stores the characteristic information in, for example, the RAM 12 in association with the print data.

The characteristic determining unit 102 is an example of a determining unit. The characteristic determining unit 102 determines the characteristic of print data. For example, the characteristic determining unit 102 analyzes the content and data structure of the print data to determine whether the print data is alphabetic data or kanji data. As another example, the characteristic determining unit 102 analyzes the content and data structure of the print data to determine whether the majority of characters to be printed are one-byte characters or two-byte characters. As another example, the characteristic determining unit 102 analyzes the content and data structure of the print data to determine whether the content is a barcode or a graphic.

Also, the characteristic determining unit 102 may determine the characteristic of print data based on characteristic information transmitted from the host device together with the print data.

The print control unit 103 is an example of a control unit. The print control unit 103 controls the operation of the motor drive unit 14 and the head drive unit 15 to perform printing of print data.

In addition, when printing print data, the print control unit 103 performs thermal history control on each heating element based on the strobe setting information 131, the target dot setting information 132, and the calculation formula information 133.

Specifically, based on the characteristic of print data determined by the characteristic determining unit 102, the print control unit 103 selects a set of calculation formulas corresponding to the characteristic from the calculation formula information 133. Next, the print control unit 103 acquires the bit values of a target dot and surrounding dots from the print data based on the positional relationship between the target dot and the surrounding dots defined in the target dot setting information 132. Next, the print control unit 103 calculates strobe values for Sub 1, Sub 2, and Main by substituting the acquired bit values into the selected set of calculation formulas. Then, the print control unit 103 identifies an application pattern corresponding to the calculated strobe values from the strobe setting information 131, and sets the identified application pattern for the target dot.

In this manner, the print control unit 103 sets an application pattern for each of dots, i.e., target dots, included in each of lines constituting the print data. The print control unit 103 then applies a strobe to heating elements based on the set application patterns and thereby prints the print data line by line. In other words, the print control unit 103 performs thermal history control according to the characteristic of the print data.

Here, it is assumed that application patterns are set prior to printing. For example, the print control unit 103 sets application patterns for a predetermined number of lines and then starts printing. Then, in parallel with the printing operation, the print control unit 103 sequentially sets application patterns for subsequent lines.

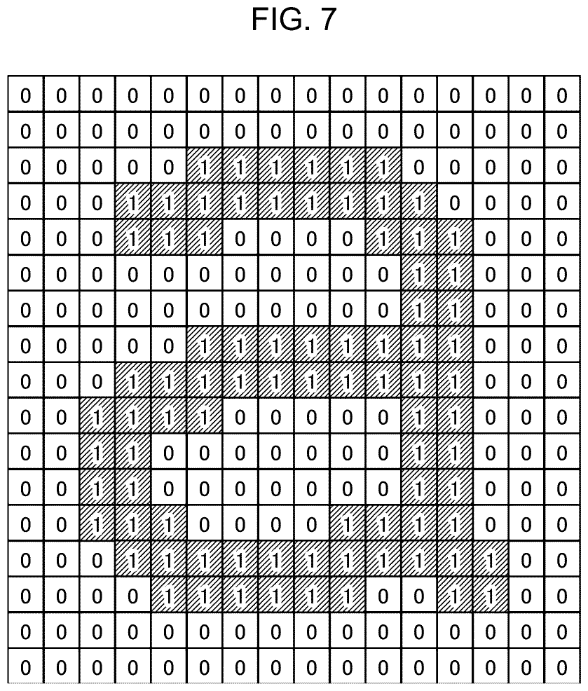

An example of an operation of the print control unit 103 will be described below with reference to FIGS. 7 to 10. FIG. 7 is a diagram showing an example of print data. Specifically, FIG. 7 shows a part of a data structure of print data that is alphabetic data.

In FIG. 7, the row direction corresponds to the line direction. Printing is performed sequentially from upper lines to lower lines. The print data is constituted by multiple dots, and whether each dot is to be printed is indicated by a binary bit value. Here, a bit value of “1” indicates that the dot is to be printed, and a bit value of “0” indicates that the dot is not to be printed. For example, in FIG. 7, a letter “a” to be printed is represented by dot areas with a bit value of “1”.

In the case of the print data of FIG. 7, the characteristic determining unit 102 determines that the print data is alphabetic data from the content of the print data. Then, the print control unit 103 selects a set of calculation formulas for alphabetic data (formulas (1) to (3)) from the calculation formula information 133. Also, the print control unit 103 sets each of dots included in each of lines constituting the print data of FIG. 7 as a target dot, and acquires the bit values of the target dot and surrounding dots from the print data. Next, the print control unit 103 derives the strobe values V1 to V3 by substituting the acquired bit values of the target dot and the surrounding dots into formulas (1) to (3). Next, the print control unit 103 identifies an application pattern corresponding to the derived strobe values from the strobe setting information 131 and sets the identified application pattern for the target dot.

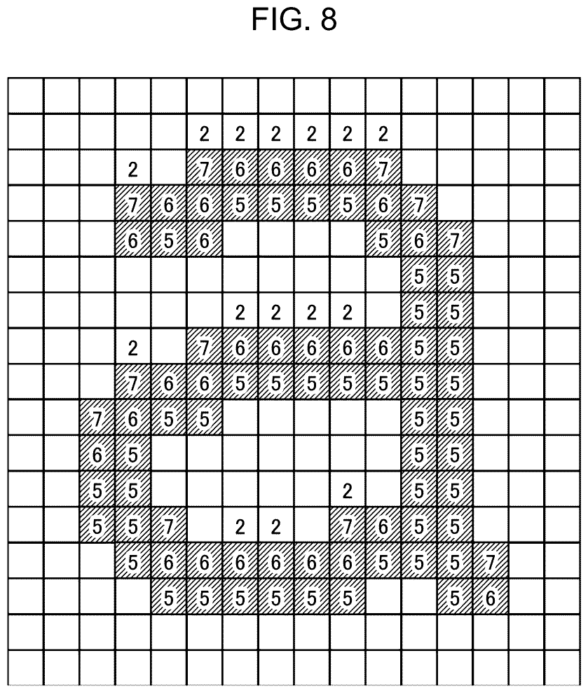

FIG. 8 is a diagram showing an example of a state in which application patterns are set in the print data of FIG. 7. The values of the application patterns are based on the strobe setting information 131 shown in FIG. 3. Also, each blank dot indicates that 0 is set for all of Sub 1, Sub 2, and Main.

In FIG. 8, application patterns are set even for some of dots having a bit value of “0” in FIG. 7 according to thermal history control that takes into account the surrounding effective dots. Also, in FIG. 8, application patterns with application durations less than 100% are set even for some of dots having a bit value of “1” in FIG. 7 according to thermal history control that takes into account the surrounding effective dots.

For example, when no print dot with a bit value of “1” is present around a dot with a bit value of “1”, an application pattern with a short application duration is set for the preceding dot with a bit value of “0” for preheating. Also, for example, when other print dots with a bit value of “1” are present around a print dot with a bit value of “1”, an application pattern with an application duration less than 100% is set for the dot considering the influence of heat accumulation.

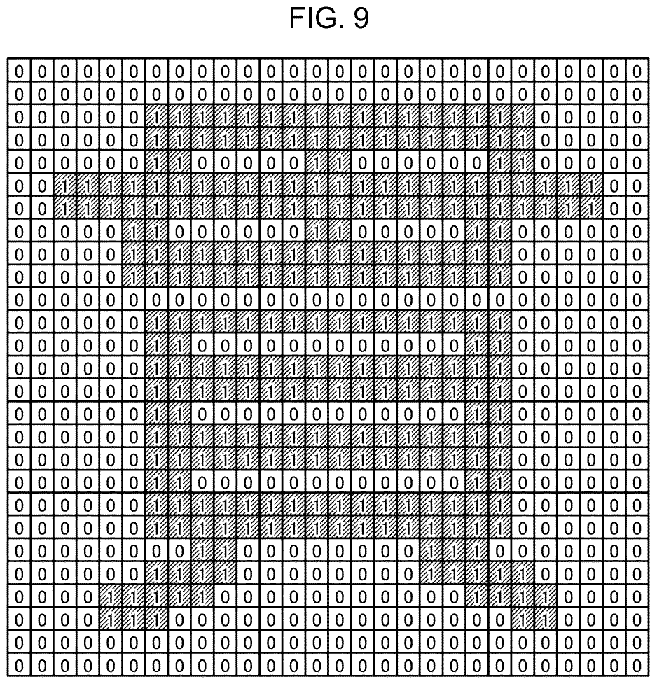

FIG. 9 is a diagram showing an example of print data. Specifically, FIG. 9 shows a part of a data structure of print data that is kanji data. In FIG. 9, a kanji character to be printed is represented by dot areas with a bit value of “1”.

In the case of the print data of FIG. 9, the characteristic determining unit 102 determines that the print data is kanji data from the content of the print data. Then, the print control unit 103 selects a set of calculation formulas for kanji data (formulas (4) to (6)) from the calculation formula information 133. Also, the print control unit 103 sets each of dots included in each of lines constituting the print data of FIG. 9 as a target dot, and acquires the bit values of the target dot and surrounding dots from the print data. Next, the print control unit 103 derives the strobe values V1 to V3 by substituting the acquired bit values of the target dot and the surrounding dots into formulas (4) to (6). Next, the print control unit 103 identifies an application pattern corresponding to the derived strobe values from the strobe setting information 131, and sets the identified application pattern for the target dot.

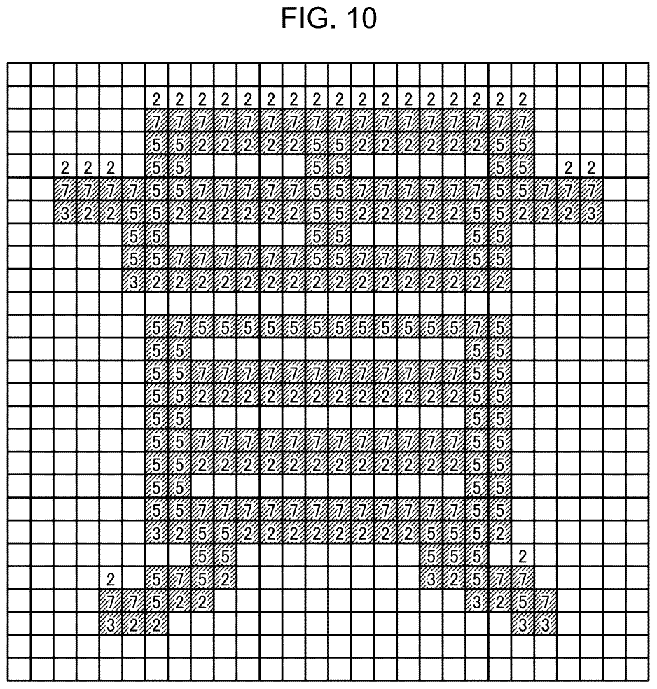

FIG. 10 is a diagram showing an example of a state in which application patterns are set in the print data of FIG. 9. In FIG. 10, similarly to FIG. 8, application patterns are set according to thermal history control.

Compared with FIG. 7, the gap between dot areas with a bit value of “1” is narrower in FIG. 9 due to the difference in the characteristic of the print data, i.e., the difference in the character type. For this reason, the printer 10 of the present embodiment is configured to select a set of calculation formulas for deriving application patterns based on the characteristic of print data. This enables the printer 10 to perform thermal history control suited to the characteristic of print data, thereby improving print quality.

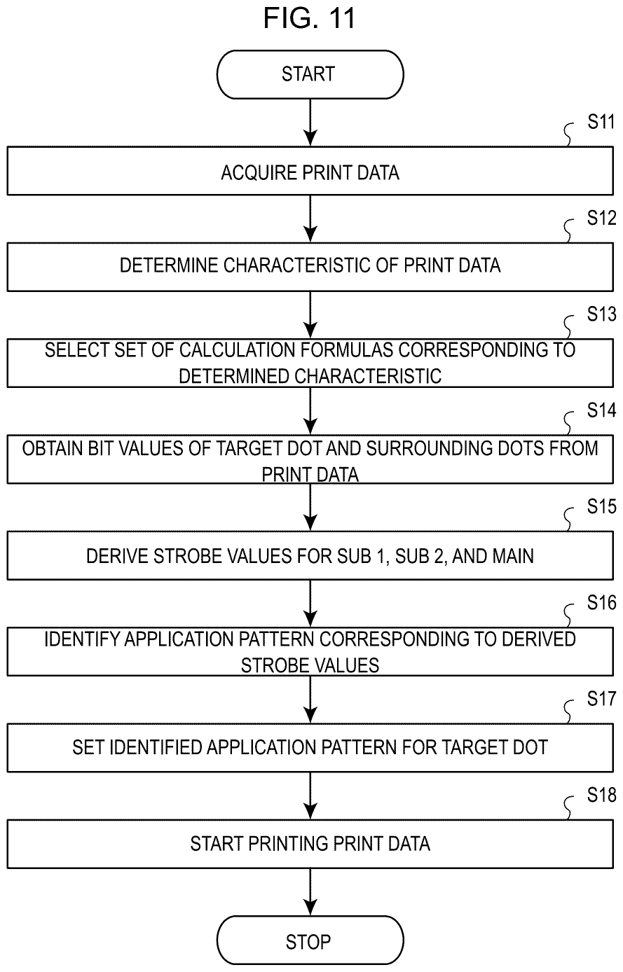

An example of an operation of the printer 10 will be described below with reference to FIG. 11. FIG. 11 is a flowchart showing an example of a process performed by the printer 10 of the embodiment. The processor (CPU 11) of the printer 10 may be configured to execute a program stored in a memory (the RAM 12 or the storage unit 13) to perform the steps in the process described below.

When print data is transmitted from a host device, the print data acquisition unit 101 acquires the print data via the communication interface 17 (step S11). The acquired print data is stored in the RAM 12 or the like. When characteristic information is also transmitted from the host device, the print data acquisition unit 101 acquires the characteristic information together with the print data and stores the characteristic information in the RAM 12 or the like.

Next, the characteristic determining unit 102 determines the characteristic of the print data acquired at step S11 (step S12). For example, the characteristic determining unit 102 determines the characteristic of the print data based on the content or data structure of the print data. Also, for example, the characteristic determining unit 102 determines the characteristic of the print data based on the characteristic information of the print data.

Next, the print control unit 103 selects a set of calculation formulas corresponding to the determined characteristic of the print data from the calculation formula information 133 (step S13). Next, the print control unit 103 obtains the bit values of a target dot and surrounding dots in one of lines constituting the print data (step S14).

Next, the print control unit 103 substitutes the bit values obtained at step S14 into the set of calculation formulas selected at step S13 to derive strobe values for Sub 1, Sub 2, and Main (step S15). Next, the print control unit 103 identifies an application pattern corresponding to the derived strobe values from the strobe setting information 131 (step S16), and sets the identified application pattern for the target dot (step S17).

Steps S14, S15, S16, and S17 are performed for each of dots included in lines constituting the print data. After the application patterns are set for a predetermined number of lines, the print control unit 103 starts printing the print data based on the set application patterns (step S18). After step S18, the print control unit 103 continues the printing operation while sequentially setting application patterns for the remaining lines.

As described above, the printer 10 of the present embodiment includes the thermal head 1 including multiple heating elements arranged in a line, the print data acquisition unit 101 that acquires print data to be printed, the characteristic determining unit 102 that determines the characteristic of the print data, and the print control unit 103 that controls the heat generation of the heating elements to print the content represented by the print data line by line. In addition, the print control unit 103 performs thermal history control for controlling the amount of heat generated by each of the heating elements based on the amount of heat stored during the process of printing the print data according to the determination result of the characteristic determining unit 102.

With the above configuration, the printer 10 of the present embodiment can perform appropriate thermal history control for various types of print data with different characteristics. Therefore, the printer 10 can effectively and flexibly perform thermal history control according to the characteristic of print data and can thereby improve print quality.

The printer 10 of the present embodiment further includes the calculation formula information 133 that includes multiple sets of calculation formulas for thermal history control for different characteristics of print data. The printer 10 performs thermal history control using a set of calculation formulas that is selected from the multiple sets of calculation formulas in the calculation formula information 133 based on the determination result of the characteristic determining unit 102.

With the above configuration, the printer 10 of the present embodiment can use different sets of calculation formulas depending on the characteristics of print data and can therefore perform thermal history control efficiently and accurately according to the characteristics of print data.

In addition, the printer 10 of the present embodiment applies a strobe to each heating element in multiple stages and controls the amount of heat generated by the heating element by turning on or off the strobe in the respective stages.

With this configuration, the printer 10 of the present embodiment can efficiently control the amount of heat generated by each heating element and can therefore efficiently perform thermal history control.

The calculation formula information 133 includes multiple sets of calculation formulas for determining whether to turn or off the strobe in each of stages. The printer 10 of the present embodiment performs thermal history control based on application patterns derived using a set of calculation formulas corresponding to the determination result of the characteristic determining unit 102.

With this configuration, the printer 10 of the present embodiment can derive application patterns using calculation formulas suitable for the characteristic of print data and can efficiently perform thermal history control according to the characteristic of the print data.

The above-described embodiment can be modified as appropriate by changing parts of the configurations or functions described above. Some variations of the above-described embodiment will be described below as other embodiments. Below, differences from the above-described embodiment are mainly described, and detailed descriptions of common features may be omitted. The variations described below may be implemented individually or in any appropriate combination.

### Variation 1

In the above embodiment, the printer 10 performs printing on the sheet 3, which is a thermal paper. However, the present disclosure may also be applied to a printer that performs printing on a sheet using an ink ribbon. Also, the sheet 3 may be any type of recording medium, such a receipt sheet, a label sheet, or a label sheet (so-called linerless label) without backing paper or a release liner.

### Variation 2

In the above-described embodiment, sets of calculation formulas for deriving strobe values are provided for alphabetic data and kanji data. However, calculation formulas are not limited to these two types, and calculation formulas may be provided for three or more characteristics that can be determined by the characteristic determining unit 102.

Furthermore, the characteristic determining unit 102 may determine multiple characteristics for the same print data. For example, the characteristic determining unit 102 may determine the characteristic of each area constituted by a predetermined number of lines (e.g., 200 lines). In this case, the print control unit 103 may select a set of calculation formulas for each group of a predetermined number of lines based on the characteristics determined by the characteristic determining unit 102.

For example, when the same print data includes an area including alphabetic characters, an area including kanji characters, and an area including code symbols, such as barcodes, the above configuration makes it possible to perform thermal history control suited to the characteristics of the areas. Accordingly, the printer 10 according to this variation can further improve print quality.

Programs to be executed by the printer 10 of the above embodiment may be provided on a computer-readable storage medium, such as a CD-ROM, a flexible disk (FD), a CD-R, or a digital versatile disk (DVD), in an installable or executable format.

Also, programs to be executed by the printer 10 of the above embodiment may be stored in a computer connected to a network, such as the Internet, and may be downloaded via the network. Also, programs to be executed by the printer 10 of the above embodiment may be provided or distributed via a network such as the Internet.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a thermal head including multiple heating elements arranged in a line;
a memory; and
a processor configured to execute a program stored in the memory to perform the steps of:
obtaining print data to be printed,
determining a characteristic of the print data, and
controlling the thermal head to print the print data line by line using thermal history control based on the determined characteristic of the print data, wherein the thermal history control controls an amount of heat to be generated by each of the heating elements considering an amount of heat that has been stored in the each of the heating elements during a process of printing the print data.

2. The printer according to claim 1, wherein the characteristic of the print data is determined based on density of dots included in the print data.

3. The printer according to claim 1, wherein
the steps further include obtaining characteristic information indicating the characteristic of the print data together with the print data; and
the characteristic of the print data is determined based on the characteristic information.

4. The printer according to claim 1, further comprising:
a storage device that stores multiple sets of calculation formulas corresponding to characteristics of multiple types of print data, wherein
the steps further include selecting a set of calculation formulas from the multiple sets of calculation formulas stored in the storage device based on the determined characteristic of the print data; and
the thermal history control is performed using the selected set of calculation formulas.

5. The printer according to claim 4, wherein
in printing the print data, a strobe is applied to each of selected heating elements among the heating elements of the thermal head in multiple stages to cause the each of the selected heating elements to generate heat, the multiple stages representing durations for which the strobe is applied; and
the amount of heat generated by the each of the selected heating elements is controlled by turning on or off the strobe in each of the multiple stages.

6. The printer according to claim 5, wherein each of the sets of calculation formulas stored in the storage device includes a calculation formula for each of the multiple stages.

7. The printer according to claim 5, wherein
the storage device also stores application patterns each of which indicates whether the strobe is turned on or off in each of the multiple stages; and
the steps further include identifying an application pattern among the application patterns stored in the storage device by using the selected set of calculation formulas.

8. The printer according to claim 7, wherein
the steps further include:
selecting each of dots included in each of lines constituting the print data as a target dot, and
obtaining bit values of the target dot and surrounding dots around the target dot from the print data; and
in the thermal history control, the amount of heat generated by one of the heating elements for printing the target dot is controlled based on the bit values of the target dot and the surrounding dots.

9. The printer according to claim 8, wherein
the steps further include substituting the bit values of the target dot and the surrounding dots into the selected set of calculation formulas to obtain, for the multiple stages, strobe values indicating whether the strobe is turned on or off;
the application pattern is identified based on the obtained strobe values; and
the identified application pattern is set for the target dot.

10. The printer according to claim 8, wherein
the storage device also stores target dot setting information defining a positional relationship between the target dot and the surrounding dots; and
the bit values of the target dot and the surrounding dots are obtained from the print data based on the target dot setting information.

11. A method performed by a printer that includes a thermal head including multiple heating elements arranged in a line, the method comprising:
obtaining print data to be printed;
determining a characteristic of the print data; and
controlling the thermal head to print the print data line by line using thermal history control based on the determined characteristic of the print data, wherein the thermal history control controls an amount of heat to be generated by each of the heating elements considering an amount of heat that has been stored in the each of the heating elements during a process of printing the print data.

12. The method according to claim 11, wherein the characteristic of the print data is determined based on density of dots included in the print data.

13. The method according to claim 11, further comprising:
obtaining characteristic information indicating the characteristic of the print data together with the print data,
wherein the characteristic of the print data is determined based on the characteristic information.

14. The method according to claim 11, further comprising:
selecting a set of calculation formulas from multiple sets of calculation formulas stored in a storage device of the printer based on the determined characteristic of the print data, the multiple sets of calculation formulas corresponding to characteristics of multiple types of print data,
wherein the thermal history control is performed using the selected set of calculation formulas.

15. The method according to claim 14, wherein
in printing the print data, a strobe is applied to each of selected heating elements among the heating elements of the thermal head in multiple stages to cause the each of the selected heating elements to generate heat, the multiple stages representing durations for which the strobe is applied; and
the amount of heat generated by the each of the selected heating elements is controlled by turning on or off the strobe in each of the multiple stages.

16. The method according to claim 15, wherein each of the sets of calculation formulas stored in the storage device includes a calculation formula for each of the multiple stages.

17. The method according to claim 15, further comprising:
identifying an application pattern among application patterns stored in the storage device by using the selected set of calculation formulas, each of the application patterns indicating whether the strobe is turned on or off in each of the multiple stages.

18. The method according to claim 17, further comprising:
selecting each of dots included in each of lines constituting the print data as a target dot; and
obtaining bit values of the target dot and surrounding dots around the target dot from the print data, wherein
in the thermal history control, the amount of heat generated by one of the heating elements for printing the target dot is controlled based on the bit values of the target dot and the surrounding dots.

19. The method according to claim 18, further comprising:
substituting the bit values of the target dot and the surrounding dots into the selected set of calculation formulas to obtain, for the multiple stages, strobe values indicating whether the strobe is turned on or off, wherein
the application pattern is identified based on the obtained strobe values, and
the identified application pattern is set for the target dot.

20. A non-transitory computer readable storage medium storing a program for causing a processor of a printer, which includes a thermal head including multiple heating elements arranged in a line, to perform a process including:
obtaining print data to be printed;
determining a characteristic of the print data; and
controlling the thermal head to print the print data line by line using thermal history control based on the determined characteristic of the print data, wherein the thermal history control controls an amount of heat to be generated by each of the heating elements considering an amount of heat that has been stored in the each of the heating elements during a process of printing the print data.
